(19) United States
(12) Patent Application Publication
(10) Pub. No.: US 2024/0069974 A1
(43) Pub. Date: Feb. 29, 2024

(54) WORKLOAD SCHEDULER FOR HIGH AVAILABILITY

(71) Applicant: International Business Machines Corporation, Armonk, NY (US)

(72) Inventors: Fei Qi, Xi'an (CN); Jian Feng Wang, Xi'An (CN); Meng Jie Li, Xi'An (CN); Rui Gao, Xian (CN); A Long Zhi, Xian (CN)

(21) Appl. No.: 17/822,155

(22) Filed: Aug. 25, 2022

(51) Int. Cl. G06F 9/50

(52) U.S. Cl. CPC G06F 9/505; G06F 11/0751

(57) ABSTRACT

A system may include a memory and a processor in communication with the memory. The processor may be configured to perform operations. The operations may include synchronizing a policy between a primary node and a compute node and maintaining a resource registry on a client of the primary node. The operations may include communicating a direct communication between the client and the compute node, and the direct communication may include a first task. The operations may include returning a first result for the first task directly from the compute node to the client.

### BACKGROUND

The present disclosure relates to distributed systems, and, more specifically, to workload management in distributed systems.

Workload scheduling and workload distribution are common functions in the computer field, including in distributed systems. Distributed systems may include, for example, open-source container systems. Open-source container systems such as clusters offer adaptive load balancing, service registration, deployment, operation, resource scheduling, and capacity scaling.

In a distributed system, a primary node may have the responsibility of managing the system resources, resource allocation policies, and task scheduling. The primary node may also have the responsibility of responding each client resource request and managing resource request requirements. If the primary node is unable to perform its functions, requests from a client may be rejected because the management role is vacant. When a primary node becomes unavailable, an alternative such as a primary node candidate may detect that the primary node is unavailable and thus assume the role of the primary node. Even so, there will be a management vacuum between the time a primary node becomes unavailable and the time when a candidate takes over the role and is able to manage the system; during this time, communication between clients and resources may be unsuccessful.

### SUMMARY

Embodiments of the present disclosure include a system, method, and computer program product for to distributed systems, and, more specifically, to workload management in distributed systems.

A system in accordance with the present disclosure may include a memory and a processor in communication with the memory. The processor may be configured to perform operations. The operations may include synchronizing a policy between a primary node and a compute node and maintaining a resource registry on a client of the primary node. The operations may include communicating a direct communication between the client and the compute node, and the direct communication may include a first task. The operations may include returning a first result for the first task directly from the compute node to the client.

The above summary is not intended to describe each illustrated embodiment or every implementation of the disclosure.

### BRIEF DESCRIPTION OF THE DRAWINGS

The drawings included in the present application are incorporated into, and form part of, the specification. They illustrate embodiments of the present disclosure and, along with the description, serve to explain the principles of the disclosure. The drawings are only illustrative of certain embodiments and do not limit the disclosure.

FIG. 1 illustrates the architecture of a system in accordance with some embodiments of the present disclosure.

FIG. 2 depicts a system in accordance with some embodiments of the present disclosure.

FIG. 3 illustrates a system in accordance with some embodiments of the present disclosure.

FIG. 4 depicts a system in accordance with some embodiments of the present disclosure.

FIG. 5 illustrates a system in accordance with some embodiments of the present disclosure.

FIG. 6 depicts a computer-implemented method in accordance with some embodiments of the present disclosure.

FIG. 7 illustrates a computer-implemented method in accordance with some embodiments of the present disclosure.

FIG. 8 depicts a cloud computing environment in accordance with embodiments of the present disclosure.

FIG. 9 illustrates abstraction model layers in accordance with embodiments of the present disclosure.

FIG. 10 depicts a high-level block diagram of an example computer system that may be used in implementing one or more of the methods, tools, and modules, and any related functions, described herein, in accordance with embodiments of the present disclosure.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention.

### DETAILED DESCRIPTION

Aspects of the present disclosure relate to distributed systems, and, more specifically, to workload management in distributed systems.

In a distributed system, a primary node may have the responsibility of managing the compute resources, resource allocation policies, and/or task scheduling of a cluster. The primary node may also have the responsibility of responding to each client resource request and managing resource request requirements. If the primary node is unable to perform its functions (e.g., rebooting or otherwise inaccessible), the compute requests from client side may be rejected as a result. To keep the primary node role alive, multiple hosts may act as a primary node candidate; these candidate hosts may install and configure the same as the primary node except that nothing is running on them and they use a thread to monitor the availability of the primary node. If the primary node crashes, a candidate host may detect the primary-down event and take over the role as the primary node.

However, from the moment the primary node becomes unavailable (e.g., at the time of the crash), there may be some time before a candidate host takes over the primary role. For example, in some systems, it may take three to five minutes for a candidate node to assume the primary role; in other systems, it may take hours or days for the primary role to be filled. During this time, any new client requests may fail as no primary node is managing them. Between the moment of the primary node becoming unavailable and the moment a candidate assumes the primary node responsibilities, the congruity of the workload may be broken.

In accordance with the present disclosure, client requests may be managed during a time when a primary node is unavailable or inaccessible (e.g., when the primary node is down). In some embodiments, between the primary node becoming unavailable and the primary node role being filled (e.g., during a primary node outage), resource management may change so as to enable a workaround to handle requests until a primary node is once again operable.

In accordance with the present disclosure, the resource request management and/or assignment may be redirected from an unavailable primary node to a direct communication model between client and computation component. In some embodiments, a client may directly request resources and/or tasks from a computation component. In some embodiments, a compute node may solicit tasks to perform from a client.

In accordance with the present disclosure, while a primary node is down, new tasks may still obtain compute resources and continue to run. In some embodiments, client searches may pair a task with compute resources to complete the task; in some embodiments, a compute node may actively seek a task from a client that the compute node may perform based on policies and its available resources. In some embodiments, new tasks may be scheduled using the same policy as the original scheduler (e.g., the policy that the primary node was using); a compute node may, for example, inherit task policies from a primary node and retrieve one or more tasks from each client in accordance with the inherited task policies.

In accordance with some embodiments of the present disclosure, a primary node may be enabled to synchronize scheduling policies to compute nodes periodically while the primary node is alive. Simultaneously, a client may be aware of available computation resources. Policy may be saved to a compute node; the policy may be, for example, scheduling policy. The policy may be saved by structure, such as the client priority, resource plan, and the like. Each client may keep its own compute list information; the compute list information may contain, for example, internet protocol (IP), operating system (OS), service, and similar information.

In accordance with the present disclosure, a client may be enabled to store a task list in a local memory, and the client may notify one or more compute nodes that the primary node is unavailable. The client may notify the compute node(s) by searching the local compute list information. The client may search the local compute list information when the primary node is unavailable and when the client has one or more pending tasks to submit for computation.

The compute node(s) may receive the notification from the client that the primary node is unavailable. The compute node(s) may fetch one or more pending tasks from the clients based on resource capacity and system policies (e.g., scheduling policies). The compute node(s) may run the tasks within the relevant policy; when the task is finished, the compute node(s) may return the task results to the client and keep the task running history in the local memory. When the primary node is back to normal, the compute node may synchronize with the primary node to report the task running history to the primary node; the primary node may continue the normal course of operation by scheduling any new coming tasks.

In accordance with the present disclosure, workload downtime during a management component (e.g., a control plane or primary node) downtime (e.g., a failure event or a maintenance occurrence) may be minimized. Additionally, the workload scheduler policy impact during the downtime may also be minimized. In accordance with the present disclosure, a system may run continuously, even during management component downtime.

A system in accordance with the present disclosure may include a memory and a processor in communication with the memory. The processor may be configured to perform operations. The operations may include synchronizing a policy between a primary node and a compute node and maintaining a resource registry on a client of the primary node. The operations may include communicating a direct communication between the client and the compute node, and the direct communication may include a first task. The operations may include returning a first result for the first task directly from the compute node to the client.

In some embodiments of the present disclosure, the operations may include identifying a failure of the primary node. In some embodiments, the operations may include notifying the compute node of the failure of the primary node. In some embodiments, the operations may further include receiving the notification, fetching the first task, and allowing the compute node to return the first result to the client.

In some embodiments of the present disclosure, the operations may include enabling the client to store a task list in a local memory of the client. In some embodiments, the operations may include storing a task list on a local memory of the client.

In some embodiments, the operations may include continuing to run the first task in the local memory of the compute node upon completion of the first task. In some embodiments, the operations may further include reporting the first task and first result to the primary node and concluding the first task.

In some embodiments of the present disclosure, the operations may include triggering the direct communication by the failure of the primary node. In some embodiments, the trigger may be the identification of a system management error.

In some embodiments of the present disclosure, the operations may include compiling a task history of the first task and the first result and reporting the task history to the primary node. In some embodiments, the operations may include identifying that the primary node has a status of online, and the status of the primary node as online may be a trigger for reporting the task history to the primary node.

In some embodiments of the present disclosure, the operations may include scheduling, via the primary node, a pending task from the client to the compute note. In some embodiments, the primary node may schedule one or more tasks from the client to the compute node, the primary node may go offline during execution of the one or more tasks, and the compute node may report any task results directly to the client upon completion of the one or more tasks.

In some embodiments of the present disclosure, the operations may include searching the resource registry for resource availability. Resource availability may include, for example, space, computation, processing, or similar capacity of one or more compute nodes in a cluster.

In some embodiments of the present disclosure, the operations may include identifying the first task is within the policy. For example, multiple tasks may be identified, and the first task may be selected from the multiple tasks because the first task satisfies one or more scheduling policy requirements or because the first task ranks the highest in a ranking system established by the scheduling policy requirements.

In some embodiments of the present disclosure, the operations may include saving the policy by structure. The structure may include, for example, a client priority, a resource plan, and the like.

In some embodiments of the present disclosure, the resource registry may include information about the client. The information about the client may include, for example, the IP of the client, the OS of the client, the service of the client, and the like.

In some embodiments of the present disclosure, the direct communication may include a second task, and the operations may further include prioritizing, by the compute node, the first task based on the scheduling policy.

In some embodiments of the present disclosure, the policy may be synchronized periodically. The period for synchronizing the policy may be set according to a default setting, be manually set by a user (e.g., a developer or administrator), or have a default setting which a user may configure. The period may be, for example, hourly, daily, weekly, or the like.

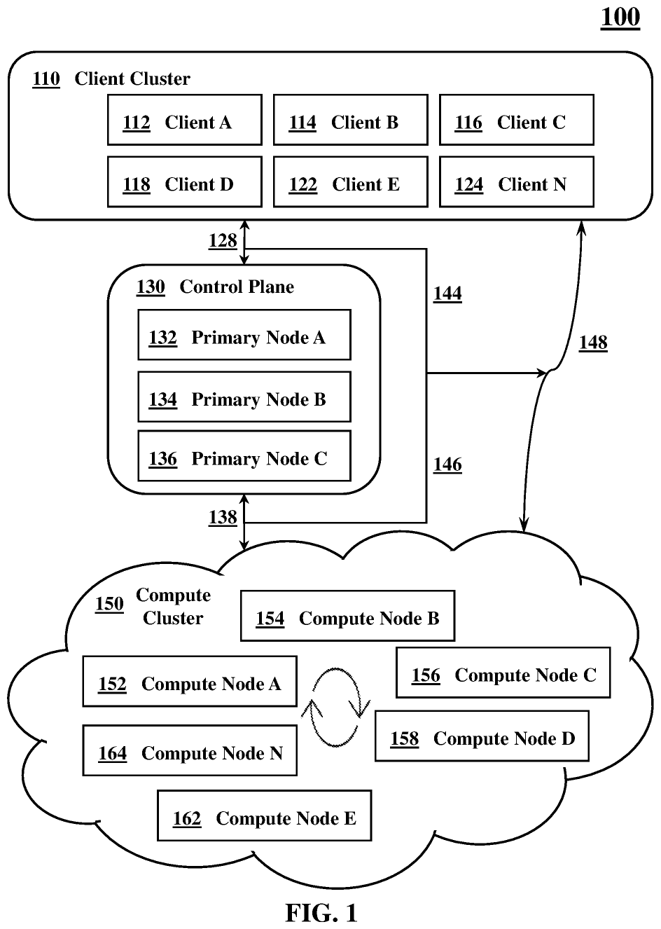

FIG. 1 illustrates the architecture of a system 100 in accordance with some embodiments of the present disclosure. The system 100 includes a client cluster 110, a control plane 130, and a compute cluster 150.

The client cluster 110 includes clients 112-124. The client cluster 110 communicates with the control plane 130 via the request route 128. The control plane 130 receives the communication via the request route 128 and channels the communication to one of the primary nodes 132-136 which may select and assign a task to one of the compute nodes 152-164 in the compute cluster 150 via the task assignment route 138.

In some situations, the request route 128, task assignment route 138, control plane 130, and/or primary nodes 132-136 may be inaccessible, down, or otherwise unavailable. For example, the control plane 130 connections (e.g., the request route 128 and the task assignment route 138) may be completely lost because the control plane 130 and/or the primary nodes 132-136 may have crashed; the system 100 may be in a recovery time window such that a candidate may be pending for the role of the control plane 130. Meanwhile, the clients 112-124 may have tasks pending deployment, and the compute nodes 152-164 may have resources available for executing the tasks.

In accordance with the present disclosure, an alternate route between the client cluster 110 and the compute cluster 150 may be used. A direct communication pathway 148 may be used such that the client cluster 110 may communicate directly with the compute cluster 150 to enable, for example, task assignment, completion, and result reporting. In some embodiments, either the client cluster 110 or the compute cluster 150 may identify that the control plane 130 and/or the primary nodes 132-136 are unresponsive and may engage directly in the direct communication pathway 148.

In some embodiments, the client cluster 110 may identify an unresponsive control plane 130 and trigger the use of the direct communication pathway 148. For example, a task request submitted to the control plane 130 via the request route 128 may not be responded to, and this may trigger the use of the direct communication pathway 148. In such an embodiment, the task request may be redirected from the request route 128 to an alternate request route 144 and submitted to the direct communication pathway 148.

In some embodiments, the compute cluster 150 may identify an unresponsive control plane 130 and trigger the use of the direct communication pathway 148. For example, an executed task response submitted to the control plane 130 via the task assignment route 138 may not be responded to, and this may trigger the use of the direct communication pathway 148. In such an embodiment, the executed task response may be redirected from the task assignment route 138 to an alternate response route 146 and submitted to the direct communication pathway 148.

In some embodiments, while the control plane 130 is unavailable, the client cluster 110 and/or the clients 112-124 may store one or more task lists of tasks requested directly from the compute cluster 150 and/or its compute nodes 152-164. The task lists may be stored in local memory (e.g., individually in the clients 112-124 requesting the tasks and/or in an aggregated local memory on the client cluster 110). The client cluster 110 may request tasks of the compute cluster 150 using one or more locally stored task lists. The client cluster 110 may report any or all of the tasks to a newly available control plane 130 using the one or more locally stored task lists such as by submitting the one or more task lists to the control plane 130.

In some embodiments, while the control plane 130 is unavailable, the compute cluster 150 and/or the compute nodes 152-164 may store one or more task histories of executed tasks directly serviced by the compute cluster 150 and/or its compute nodes 152-164 in response to one or more requests from the client cluster 110. The task histories may be stored in local memory (e.g., individually in the compute nodes 152-164 executing the tasks and/or in an aggregated local memory on the compute cluster 150). The compute cluster 150 may request tasks of the compute cluster 150 using one or more locally stored task lists. The compute cluster 150 may report any or all of the executed tasks and/or results to a newly available control plane 130 using the one or more locally stored task histories such as by submitting the one or more task histories to the control plane 130.

In some embodiments, the client cluster 110 and/or the compute cluster 150 may monitor for the control plane 130 coming back online and once again becoming accessible. When the control plane 130 becomes available, the client cluster 110 and/or the compute cluster 150 may report the one or more task lists and/or the one or more task histories of any tasks requested and/or executed to the control plane 130 while the control plane 130 was unavailable. Reporting the task lists and/or task histories may enable or otherwise help the control plane 130 to efficiently continue to schedule incoming tasks and/or otherwise reengage in the management of the workload distribution of the system 100.

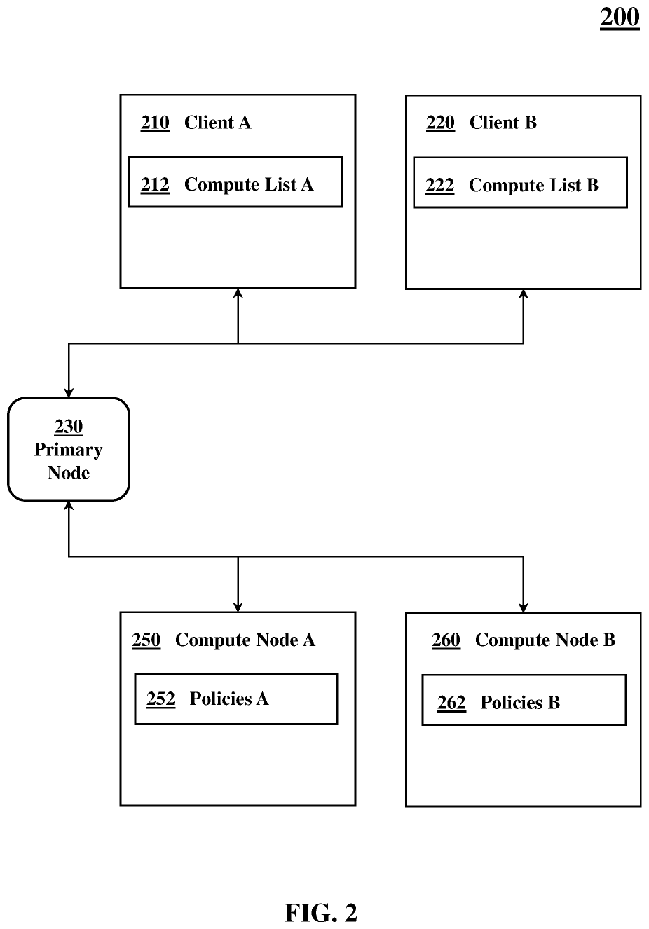

FIG. 2 depicts a system 200 in accordance with some embodiments of the present disclosure. The system 200 includes a primary node 230, clients, and compute nodes. The primary node 230 communicates with and facilitates communication between client A 210, client B 220, compute node A 250, and compute node B 260.

Client A 210 and client B 220 each maintain their own workload information, compute list A 212 and compute list B 222, respectively. The workload information maintained in the compute lists may include compute host information as may be necessary to communicate with one or more compute hosts, for example, such as IP, OS, service, and the like.

The primary node 230 may synchronize policies A 252 with compute node A 250 and policies B 262 with compute node B 260 (e.g., via the task assignment route 138 of FIG. 1). The primary node 230 may save policies to the compute nodes while the primary node 230 is running properly so as to prepare, for example, in case of a primary node 230 failure or in advance of planned primary node 230 downtime. The primary node 230 may become unavailable, for example, because of an unexpected crash or as a result of scheduled maintenance.

In some embodiments, the policies A 252 synchronized with compute node A 250 may be the same as the policies B 262 synchronized with compute node B 260; in some embodiments, the policies A 252 synchronized with compute node A 250 may be different from as the policies B 262 synchronized with compute node B 260. These policies may include the scheduling policy, client priority, task priority, resource planning, and/or similar information. For example, client A 210 may have first priority for up to twenty resource slots and priority three for any remaining resource allocation requests, and client B 220 may have second priority for up to forty resource slots, priority three for the next thirty requested resource slots, and priority four for any remaining requested priority slots.

In some embodiments, the policies may be the same across the system 200. For example, client A 210 may have the same priority for resource allocation in compute node A 250 as it has in compute node B 260. In some embodiments, the policies may differ between computational resources. For example, in compute node A 250, client A 210 may have first priority for up to twenty-five resource slots and priority three for any remaining resource allocation requests according to the policies A 252 whereas in compute node B 260, client A 210 may have second priority for up to ten resource slots and priority four for any remaining resource allocation requests according to the policies B 262.

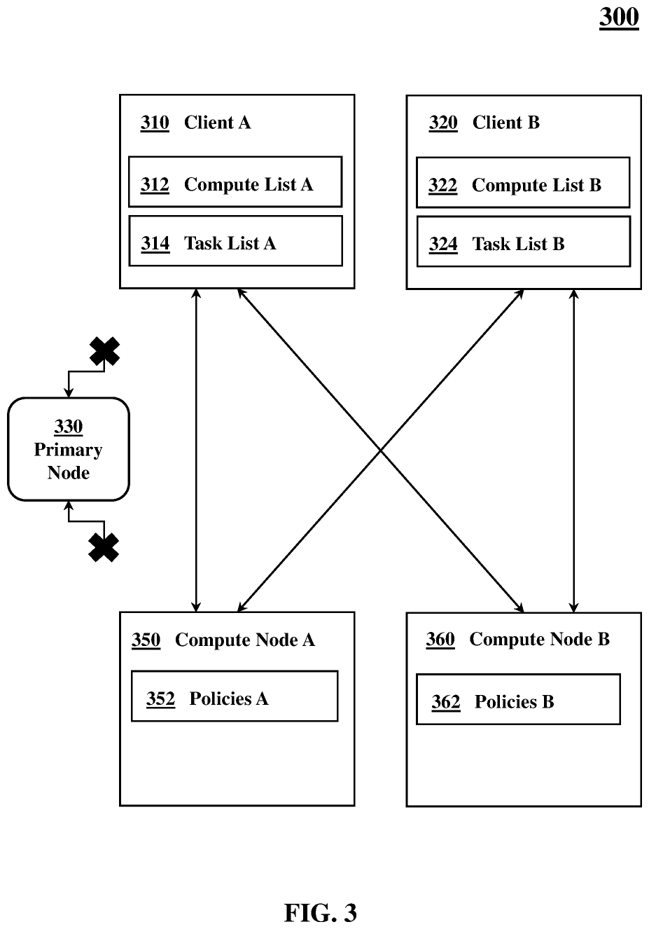

FIG. 3 illustrates a system 300 in accordance with some embodiments of the present disclosure. The system 300 includes a primary node 330, clients, and compute nodes. The primary node 330 previously communicated with and facilitated communication between client A 310, client B 320, compute node A 350, and compute node B 360; however, the primary node 330 in the system 300 is unavailable (e.g., failure or maintenance downtime).

Client A 310 and client B 320 each maintain their own workload information, compute list A 312 and compute list B 322, respectively. The workload information maintained in the compute lists may include compute host information as may be necessary to communicate with one or more compute hosts, for example, such as IP, OS, service, and the like. Client A 310 and client B 320 may maintain their own task information in local memory, task list A 314 and task list B 324, respectively. The task information may include, for example, information about tasks submitted directly to one or more compute nodes for execution. In some embodiments, the clients may start maintaining task information in local memory upon discovering that the primary node 330 is unavailable; for example, client A 310 may submit a task request to the primary node 330, receive no response, and the lack of response may trigger the client A 310 to build and maintain task list A 314.

The compute nodes have policies stored locally from when the primary node 330 synchronized the policies with the compute nodes. In some embodiments, the policies A 352 synchronized with compute node A 350 may be the same as the policies B 362 synchronized with compute node B 360; in some embodiments, the policies A 352 synchronized with compute node A 350 may be different from as the policies B 362 synchronized with compute node B 360. These policies may include the scheduling policy, client priority, task priority, resource planning, and/or similar information. For example, client A 310 may have first priority for up to twenty resource slots and priority three for any remaining resource allocation requests, and client B 320 may have second priority for up to forty resource slots, priority three for the next thirty requested resource slots, and priority four for any remaining requested priority slots.

In some embodiments, the policies may be the same across the system 300. For example, client A 310 may have the same priority for resource allocation in compute node A 350 as it has in compute node B 360. In some embodiments, the policies may differ between computational resources. For example, in compute node A 350, client A 310 may have first priority for up to twenty-five resource slots and priority three for any remaining resource allocation requests according to the policies A 352 whereas in compute node B 360, client A 310 may have second priority for up to ten resource slots and priority four for any remaining resource allocation requests according to the policies B 362.

For example, policies A 352 and policies B 362 may be the same. In these policies, client A 310 may have first priority for twenty resource slots and third priority for any additional resource slot requests, and client B 320 may have second priority for fifty resource slots and third priority for any additional resource slot requests. Client A 310 may have one hundred pending tasks, client B 320 may also have one hundred pending tasks, and the compute nodes may have one hundred available resource slots between them. According to the policies of this example, client A 310 may receive the first twenty resource slots, client B 320 may receive the next fifty resource slots, and the remaining thirty resource slots may be split between client A 310 and client B 320 such that each client may be allocated fifteen of the remaining thirty slots.

In some embodiments, according to the policies, priority may be based on task and/or task type such that certain tasks may be allocated higher priority than other tasks; in such embodiments, the compute nodes may select which tasks to execute based on task priority.

In some embodiments, a hybrid priority system may be used such that both client and task priorities are utilized. For example, client A 310 may have second priority overall whereas client B 320 may have third priority overall, and client B 320 may have one or more tasks that have first priority; according to the policies, the first priority tasks of client B 320 may be allocated the first resource slots, the client A 310 tasks may be allocated the resource slots next because client A 310 has second priority, and the remaining tasks of client B 320 may be allocated resource slots thereafter because client B 320 has third priority.

Given the primary node 330 is unreachable, the compute nodes may communicate directly with the clients (e.g., via the direct communication pathway 148 of FIG. 1). In some embodiments, the compute nodes may self-identify available resources and seek additional tasks to perform. In some embodiments, the clients may have pending tasks to complete and may request computational resources from one or more compute nodes to complete the pending tasks. In some embodiments, both mechanisms may be used to allocate tasks and/or submit task results; for example, client A 310 may submit a task request to compute node A 350, and compute node A 350 may execute the task and then report the results back to client A 310.

While the primary node 330 is unavailable, the clients may store one or more task lists locally and directly notify the compute nodes of the tasks to be completed. The compute nodes may receive any pending tasks and process the tasks based on capacity, resource availability, and the policies saved locally to the compute nodes. The compute nodes may execute the tasks and report the results from the tasks to the clients. As tasks are completed and resources once again become available, and as clients receive responses and potentially have additional task requests to submit, the compute nodes may continue executing additional task requests and submitting the responses directly to the clients.

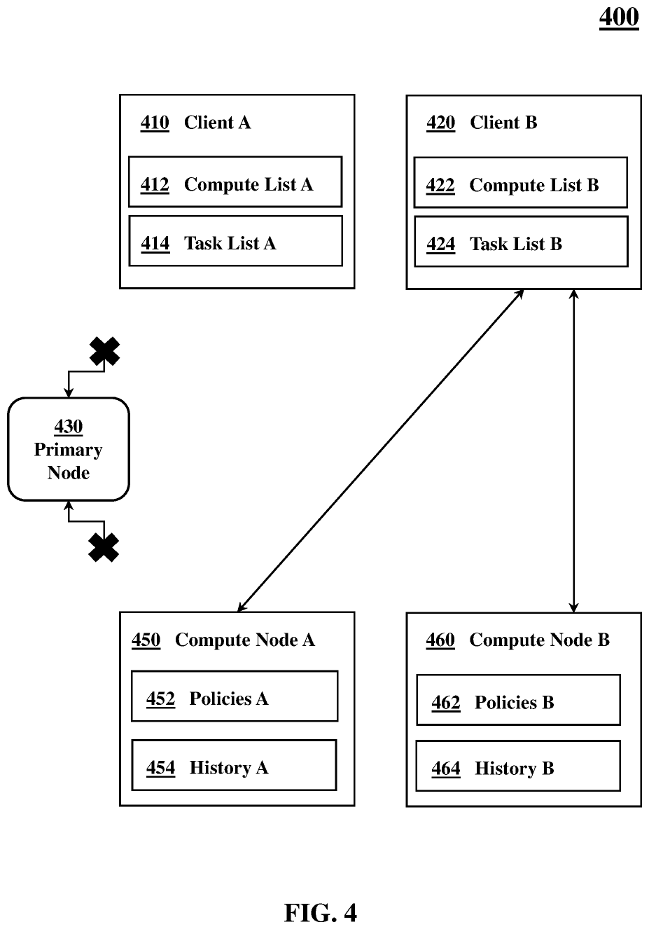

FIG. 4 depicts a system 400 in accordance with some embodiments of the present disclosure. The system 400 includes a primary node 430, clients, and compute nodes. The primary node 430 previously communicated with and facilitated communication between client A 410, client B 420, compute node A 450, and compute node B 460; however, the primary node 430 in the system 400 is unavailable (e.g., failure or maintenance downtime).

Client A 410 and client B 420 each maintain their own workload information, compute list A 412 and compute list B 422, respectively. The workload information maintained in the compute lists may include compute host information as may be necessary to communicate with one or more compute hosts, for example, such as IP, OS, service, and the like. Client A 410 and client B 420 may maintain their own task information in local memory, task list A 414 and task list B 424, respectively. The task information may include, for example, information about tasks submitted directly to one or more compute nodes for execution. In some embodiments, the clients may start maintaining task information in local memory upon discovering that the primary node 430 is unavailable; for example, client A 410 may submit a task request to the primary node 430, receive no response, and the lack of response may trigger the client A 410 to build and maintain task list A 414.

Compute node A 450 and compute node B 460 may each maintain policy information locally, policies A 452 and policies B 462, respectively. The policies may have been synchronized from the primary node 430 while the primary node 430 was available; the policies may include the scheduling policy, client priority, task priority, resource planning, and/or similar information. Compute node A 450 and compute node B 460 may each maintain task history information locally, history A 454 and history B 464, respectively. The task history may include information about the tasks performed and/or responded to while the primary node 430 is unavailable.

In the system 400, client B 420 has actively ongoing communications with both compute node A 450 and compute node B 460. For example, client B 420 may be requesting compute node B 460 complete a task while simultaneously compute node A 450 is responding to client B 420 with the results of a previous task request. Compute node A 450 returns the results from the task to client B 420 and tracks the task history in the locally saved history A 454. Similarly, when compute node B 460 completes the task client B 420 requests, compute node B 460 reports the results to client B 420 and tracks the task history in the locally saved history B 464.

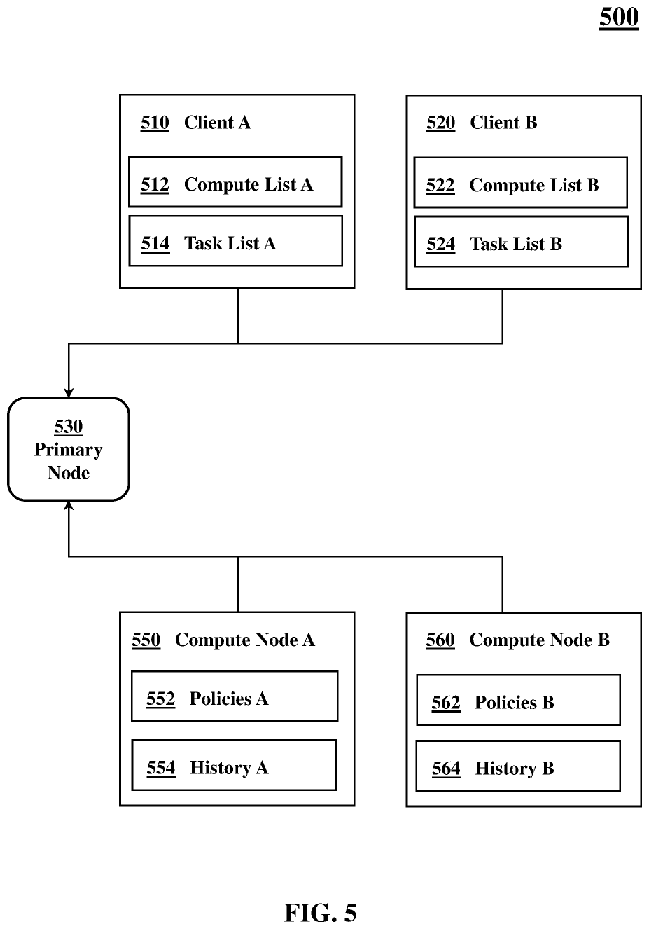

FIG. 5 illustrates a system 500 in accordance with some embodiments of the present disclosure. The system 500 includes a primary node 530, clients, and compute nodes. The primary node 530 recently returned to availability after previous unavailability (e.g., due to either failure or downtime for maintenance).

Client A 510 and client B 520 each maintain their own workload information, compute list A 512 and compute list B 522, respectively. Client A 510 and client B 520 may maintain their own task information in local memory, task list A 514 and task list B 524, respectively. In some embodiments, the clients may start maintaining task information in local memory upon discovering that the primary node 530 is unavailable; for example, client A 510 may submit a task request to the primary node 530, receive no response, and the lack of response may trigger the client A 510 to build and maintain task list A 514. In some embodiments, the clients may identify that the primary node 530 is once again available; upon discovering that the primary node 530 is available, the clients may report the task information the clients have been maintaining (e.g., task list A 514 and/or task list B 524) to the primary node 530 such that the primary node 530 may update a local database. In some embodiments, the clients may not report task information.

Compute node A 550 and compute node B 560 may each maintain policy information locally, policies A 552 and policies B 562, respectively. Compute node A 550 and compute node B 560 may each maintain task history information locally, history A 554 and history B 564, respectively; the task history may include information about the tasks performed and/or responded to while the primary node 530 is unavailable. In some embodiments, the compute nodes may identify that the primary node 530 is once again available; upon discovering that the primary node 530 is available, the compute nodes may report the task history information the compute nodes have been maintaining (e.g., history A 554 and/or history B 564) to the primary node 530 such that the primary node 530 may update a local database. In some embodiments, the compute nodes may not report task history information.

The compute nodes may synchronize with the primary node 530 once it becomes available. For example, the primary node 530 may have gone offline as part of an update, and the primary node 530 may synchronize new policies to the compute nodes when the primary node 530 becomes available. Similarly, the compute nodes may have completed one or more tasks while the primary node 530 was offline, and the compute nodes may have task information (e.g., history A 554 and/or history B 564) to synchronize with the primary node 530.

The primary node 530 may resume its workload management responsibilities when it is available. For example, the primary node 530 may reestablish connection with the clients and the compute nodes, update any relevant task history and/or databases, and engage in scheduling pending tasks for clients.

A computer-implemented method in accordance with the present disclosure may include synchronizing a policy between a primary node and a compute node and maintaining a resource registry on a client of the primary node. The method may include communicating a direct communication between the client and the compute node, and the direct communication may include a first task. The method may include returning a first result for the first task directly from the compute node to the client.

In some embodiments of the present disclosure, the method may include identifying a failure of the primary node. In some embodiments, the method may include notifying the compute node of the failure of the primary node. In some embodiments, the method may further include receiving the notification, fetching the first task, and allowing the compute node to return the first result to the client.

In some embodiments of the present disclosure, the method may include enabling the client to store a task list in a local memory of the client. In some embodiments, the method may include storing a task list on a local memory of the client.

In some embodiments, the method may include continuing to run the first task in the local memory of the compute node upon completion of the first task. In some embodiments, the method may further include reporting the first task and first result to the primary node and concluding the first task.

In some embodiments of the present disclosure, the method may include triggering the direct communication by the failure of the primary node. In some embodiments, the trigger may be the identification of a system management error.

In some embodiments of the present disclosure, the method may include compiling a task history of the first task and the first result and reporting the task history to the primary node. In some embodiments, the method may include identifying that the primary node has a status of online, and the status of the primary node as online may be a trigger for reporting the task history to the primary node.

In some embodiments of the present disclosure, the method may include scheduling, via the primary node, a pending task from the client to the compute note. In some embodiments, the primary node may schedule one or more tasks from the client to the compute node, the primary node may go offline during execution of the one or more tasks, and the compute node may report any task results directly to the client upon completion of the one or more tasks.

In some embodiments of the present disclosure, the method may include searching the resource registry for resource availability. Resource availability may include, for example, space, computation, processing, or similar capacity of one or more compute nodes in a cluster.

In some embodiments of the present disclosure, the method may include identifying the first task is within the policy. For example, multiple tasks may be identified, and the first task may be selected from the multiple tasks because the first task satisfies one or more policy requirements or because the first task ranks the highest in a ranking system established by the policy requirements.

In some embodiments of the present disclosure, the method may include saving the policy by structure. The structure may include, for example, a client priority, a resource plan, and the like.

In some embodiments of the present disclosure, the resource registry may include information about the client. The information about the client may include, for example, the IP of the client, the OS of the client, the service of the client, and the like.

In some embodiments of the present disclosure, the direct communication may include a second task, and the method may further include prioritizing, by the compute node, the first task based on the scheduling policy.

In some embodiments of the present disclosure, the policy may be synchronized periodically. The period for synchronizing the policy may be set according to a default setting, be manually set by a user (e.g., a developer or administrator), or have a default setting which a user may configure. The period may be, for example, hourly, daily, weekly, or the like.

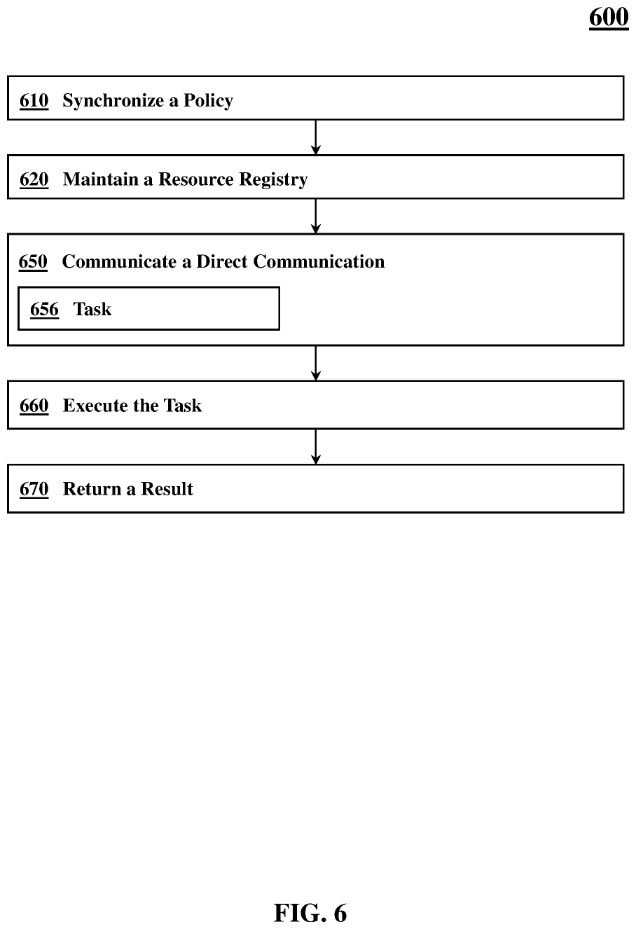

FIG. 6 depicts a computer-implemented method 600 in accordance with some embodiments of the present disclosure. The method 600 may be executed on a distributed system (e.g., system 100 of FIG. 1 or system 200 of FIG. 2). The method 600 includes synchronizing 610 a policy and maintaining 620 a resource registry. The method 600 includes communicating 650 a direct communication between a client and a computational resource; the direct communication includes a task 656. The method includes executing 660 the task 656 and returning 670 a result.

The method 600 includes synchronizing 610 a policy. The policy may be synchronized between a management actor (e.g., the control plane 130 of FIG. 1 or the primary node 230 of FIG. 2) and a computational actor (e.g., the compute cluster 150 of FIG. 1 or compute node A 250 of FIG. 2). The policy may be stored locally on the computational actor (e.g., the policies A 252 are stored on compute node A 250 in FIG. 2). The policy may include, for example, scheduling policies, workload policies, client priority, task priority, resource planning, and/or the like.

The method 600 includes maintaining 620 a resource registry. The resource registry (e.g., compute list A 212 of FIG. 2) may be built and/or maintained locally on a client (e.g., client A 112 of FIG. 1 or client A 210 of FIG. 2). The resource registry maintained on the client may include workload information such as compute host information (e.g., information about compute node A 250 of FIG. 2) as may be necessary to communicate with one or more compute hosts (e.g., compute cluster 150 or compute node E 162 of FIG. 1 or compute node A 250 of FIG. 2), for example, such as IP, OS, service, and the like.

The method 600 includes communicating 650 a direct communication between a client and a computational resource. The direct communication may be via a direct pathway such as the direct communication pathway 148 of FIG. 1. The direct communication may be via an indirect pathway such as routing a request from the request route 128 to an alternate request route 144 to the direct communication pathway 148 of FIG. 1; the direct communication may be via an indirect pathway such as routing a request from the task assignment route 138 to an alternate response route 146 to the direct communication pathway 148 of FIG. 1. The direct communication may include, for example, a task request, a resource allocation request, a response to a request, a result from a task, or the like.

The method 600 includes executing 660 the task 656. The task may be executed on the compute node (e.g., compute node N 164 of FIG. 1 or compute node A 250 of FIG. 2). The method 600 includes returning 670 a result. The result may be the result of executing 660 the task 656. The result may be returned to the client (e.g., client cluster 110 or client C 116 of FIG. 1 or client B 220 of FIG. 2) that requested the task.

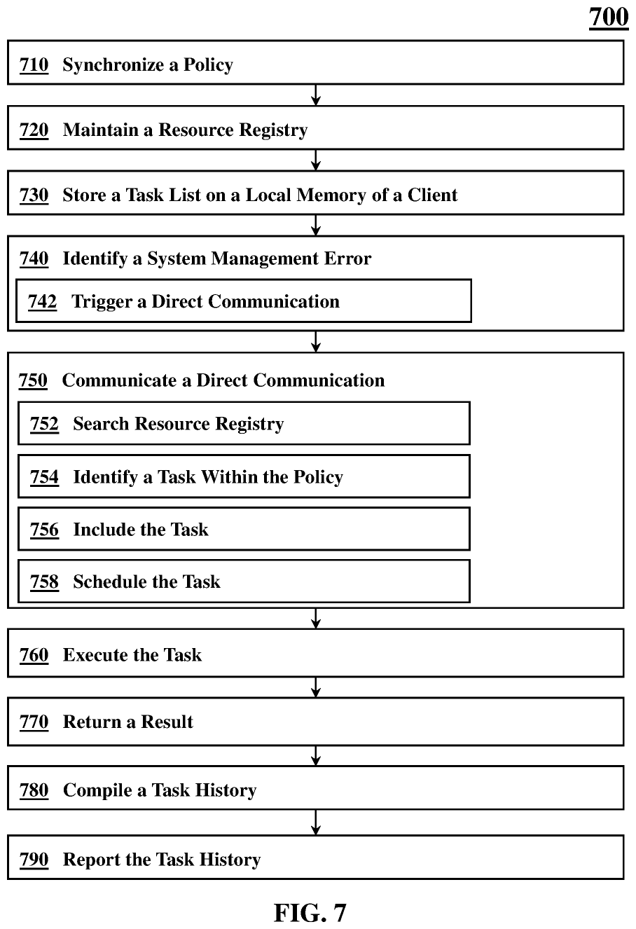

FIG. 7 illustrates a computer-implemented method 700 in accordance with some embodiments of the present disclosure. The method 700 may be executed on a distributed system (e.g., system 100 of FIG. 1 or system 200 of FIG. 2). The method 700 includes synchronizing 710 a policy and maintaining 720 a resource registry. The method 700 includes storing 730 a task list and identifying 740 a system management error (e.g., a primary node failure). The method 700 includes communicating 750 a direct communication between a client and a computational resource, executing 760 the task, and returning 770 a result. The method 700 includes compiling 780 and reporting 790 a task history.

The method 700 includes synchronizing 710 a policy. The policy may be synchronized between a management actor (e.g., the control plane 130 of FIG. 1 or the primary node 230 of FIG. 2) and a computational actor (e.g., the compute cluster 150 of FIG. 1 or compute node A 250 of FIG. 2). The policy may be stored locally on the computational actor (e.g., the policies A 252 are stored on compute node A 250 in FIG. 2). The policy may include, for example, scheduling policies, workload policies, client priority, task priority, resource planning, and/or the like.

The method 700 includes maintaining 720 a resource registry. The resource registry (e.g., compute list A 212 of FIG. 2) may be built and/or maintained locally on a client (e.g., client A 112 of FIG. 1 or client A 210 of FIG. 2). The resource registry maintained on the client may include workload information such as compute host information (e.g., information about compute node A 250 of FIG. 2) as may be necessary to communicate with one or more compute hosts (e.g., compute cluster 150 or compute node E 162 of FIG. 1 or compute node A 250 of FIG. 2), for example, such as IP, OS, service, and the like.

The method 700 includes storing 730 a task list. The task list (e.g., task list A 314 of FIG. 3 or task list B 424 of FIG. 4) may be stored on the local memory of a client (e.g., client A 112 of FIG. 1 or client A 210 of FIG. 2). The task list may store task information such as, for example, information about tasks submitted directly to one or more compute nodes for execution. In some embodiments, the clients may start storing 730 task information in local memory upon identifying 740 that a primary node (e.g., primary node 330 of FIG. 3) is unavailable; for example, a client (e.g., client A 310 of FIG. 3) may submit a task request to a primary node (e.g., primary node 330 of FIG. 3), receive no response, and the lack of response may trigger the client to build, maintain, and store a task list (e.g., task list A 314 of FIG. 3).

The method 700 includes identifying 740 a system management error. The system management error may be, for example, an unresponsiveness or unhelpful response from the component of a system (e.g., system 100 of FIG. 1 or system 200 of FIG. 2) in the management role such as the control plane (e.g., control plane 130 of FIG. 1) or a primary node (e.g., primary node 230 of FIG. 2). Identifying 740 a system management error (e.g., a primary node failure) may result in the triggering 742 of a direct communication between a client (e.g., client A 310 of FIG. 3) and a computational actor (e.g., compute node A 350 of FIG. 3).

The method 700 includes communicating 750 a direct communication between a client and a computational resource. The direct communication may be via a direct pathway (e.g., the direct communication pathway 148 of FIG. 1) or via an indirect pathway (e.g., in FIG. 1, routing a request from the request route 128 to an alternate request route 144 to the direct communication pathway 148 or routing a request from the task assignment route 138 to an alternate response route 146 to the direct communication pathway 148). The direct communication may include, for example, a task request, a resource allocation request, a response to a request, a result from a task, or other communication between a client and a computational actor.

The communicating 750 a direct communication may include searching 752 the resource registry. The resource registry (e.g., compute list A 212 of FIG. 2) may be built and/or maintained locally on a client (e.g., client A 112 of FIG. 1 or client A 210 of FIG. 2). The resource registry maintained on the client may include workload information such as compute host information (e.g., information about compute node A 250 of FIG. 2) as may be necessary to communicate with, identify, and/or select a computational actor (e.g., compute node E 162 of FIG. 1 or compute node A 250 of FIG. 2), for example, such as IP, OS, service, processing power, resource availability, and the like.

The communicating 750 a direct communication may include identifying 754 a task within the policy that was synchronized between a management actor (e.g., primary node 230 of FIG. 2) and a computational actor (e.g., compute node A 250 of FIG. 2). For example, a computational actor may detect multiple tasks including one task that complies with the synchronized policy by having the highest priority; the computational actor may select that task to execute because it is the task that best fits within the synchronized policy. The policies (e.g., policies A 252 of FIG. 2) may include the scheduling policy, client priority, task priority, resource planning, and/or similar information.

The communicating 750 a direct communication may include including 756 the task in the direct communication. For example, a client (e.g., client A 210 of FIG. 2) may submit a task request to a computational actor (e.g., compute node A 250 of FIG. 2). In some embodiments, a first direct communication may be a computational actor (e.g., compute node A 250 of FIG. 2) soliciting a task from a client (e.g., client A 210 of FIG. 2); the response may be a direct communication from the client to the computational actor, and the response may include the task.

The communicating 750 a direct communication may include scheduling 758 the task for execution via the computational actor. In some embodiments, the computational actor (e.g., compute node A 450 of FIG. 4) may immediately commence a task. In some embodiments, the computational actor (e.g., compute node A 450 of FIG. 4) may schedule a task for execution at a later time (e.g., when resources become available).

The method 700 includes executing 760 the task. The task may be executed on the compute node (e.g., compute node N 164 of FIG. 1 or compute node A 250 of FIG. 2). The method 700 includes returning 770 a result. The result may be the result of executing 760 the task 756. The result may be returned to the client (e.g., client cluster 110 or client C 116 of FIG. 1 or client B 220 of FIG. 2) that requested the task.

The method 700 includes compiling 780 a task history. A computational actor (e.g., compute node A 550 of FIG. 5) may compile, maintain, and store the task history. The task history may include information about the tasks performed and/or responded to while the primary node (e.g., primary node 530 of FIG. 5) is unavailable.

The method 700 includes reporting 790 the task history. The computational actor (e.g., compute node A 550 of FIG. 5) may detect (e.g., via response to test packets) that the management actor (e.g., control plane 130 of FIG. 1 or primary node 530 of FIG. 5) is once again available (e.g., recovered from failure or rebooted after maintenance). Upon detecting that the management actor is available, the compute node may report the task history information the computational actor has compiled (e.g., history A 554 of FIG. 5) to the management actor such that the management actor may update a database of task history on the management actor.

A computer program product in accordance with the present disclosure may include a computer readable storage medium having program instructions embodied therewith. The program instructions may be executable by a processor to cause the processor to perform a function. The function may include synchronizing a policy between a primary node and a compute node and maintaining a resource registry on a client of the primary node. The function may include communicating a direct communication between the client and the compute node, and the direct communication may include a first task. The function may include returning a first result for the first task directly from the compute node to the client.

In some embodiments of the present disclosure, the function may include identifying a failure of the primary node. In some embodiments, the function may include notifying the compute node of the failure of the primary node. In some embodiments, the function may further include receiving the notification, fetching the first task, and allowing the compute node to return the first result to the client.

In some embodiments of the present disclosure, the function may include enabling the client to store a task list in a local memory of the client. In some embodiments, the function may include storing a task list on a local memory of the client.

In some embodiments, the function may include continuing to run the first task in the local memory of the compute node upon completion of the first task. In some embodiments, the function may further include reporting the first task and first result to the primary node and concluding the first task.

In some embodiments of the present disclosure, the function may include triggering the direct communication by the failure of the primary node. In some embodiments, the trigger may be the identification of a system management error.

In some embodiments of the present disclosure, the function may include compiling a task history of the first task and the first result and reporting the task history to the primary node. In some embodiments, the function may include identifying that the primary node has a status of online, and the status of the primary node as online may be a trigger for reporting the task history to the primary node.

In some embodiments of the present disclosure, the function may include scheduling, via the primary node, a pending task from the client to the compute note. In some embodiments, the primary node may schedule one or more tasks from the client to the compute node, the primary node may go offline during execution of the one or more tasks, and the compute node may report any task results directly to the client upon completion of the one or more tasks.

In some embodiments of the present disclosure, the function may include searching the resource registry for resource availability. Resource availability may include, for example, space, computation, processing, or similar capacity of one or more compute nodes in a cluster.

In some embodiments of the present disclosure, the function may include identifying the first task is within the policy. For example, multiple tasks may be identified, and the first task may be selected from the multiple tasks because the first task satisfies one or more policy requirements or because the first task ranks the highest in a ranking system established by the policy requirements.

In some embodiments of the present disclosure, the function may include saving the policy by structure. The structure may include, for example, a client priority, a resource plan, and the like.

In some embodiments of the present disclosure, the resource registry may include information about the client. The information about the client may include, for example, the IP of the client, the OS of the client, the service of the client, and the like.

In some embodiments of the present disclosure, the direct communication may include a second task, and the function may further include prioritizing, by the compute node, the first task based on the scheduling policy.

In some embodiments of the present disclosure, the policy may be synchronized periodically. The period for synchronizing the policy may be set according to a default setting, be manually set by a user (e.g., a developer or administrator), or have a default setting which a user may configure. The period may be, for example, hourly, daily, weekly, or the like.

It is to be understood that although this disclosure includes a detailed description on cloud computing, implementation of the teachings recited herein are not limited to a cloud computing environment. Rather, embodiments of the present disclosure are capable of being implemented in conjunction with any other type of computing environment currently known or that which may be later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model with different physical and virtual resources dynamically assigned and reassigned according to demand. There is a sense of portion independence in that the consumer generally has no control or knowledge over the exact portion of the provided resources but may be able to specify portion at a higher level of abstraction (e.g., country, state, or datacenter).

Rapid elasticity: capabilities can be rapidly and elastically provisioned, in some cases automatically, to quickly scale out and rapidly release to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but the consumer has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software which may include operating systems and applications. The consumer does not manage or control the underlying cloud infrastructure but has control over operating systems, storage, and deployed applications, and the consumer possibly has limited control of select networking components (e.g., host firewalls).

Deployment models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and/or compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

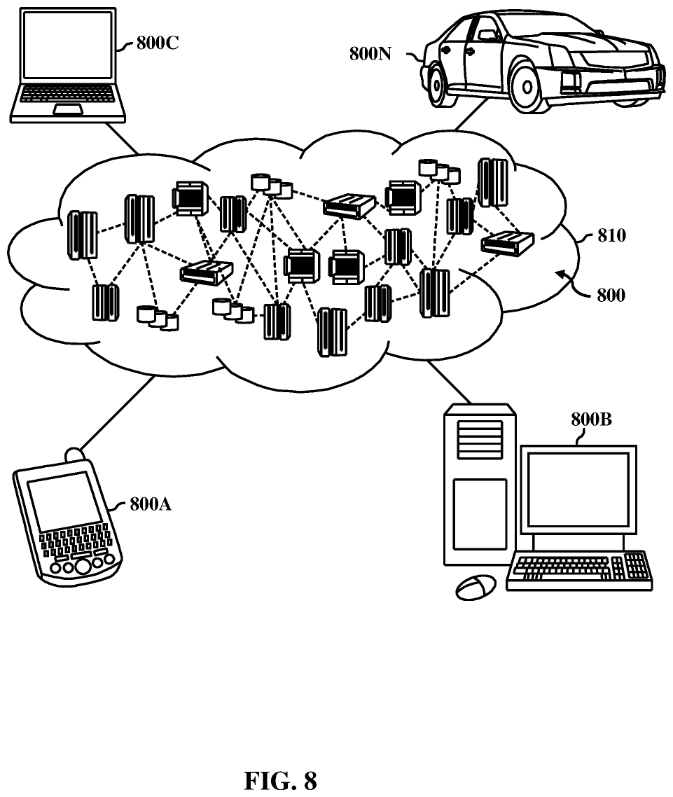

FIG. 8 illustrates a cloud computing environment 810 in accordance with embodiments of the present disclosure. As shown, cloud computing environment 810 includes one or more cloud computing nodes 800 with which local computing devices used by cloud consumers such as, for example, personal digital assistant (PDA) or cellular telephone 800A, desktop computer 800B, laptop computer 800C, and/or automobile computer system 800N may communicate. Nodes 800 may communicate with one another. They may be grouped (not shown) physically or virtually, in one or more networks, such as private, community, public, or hybrid clouds as described hereinabove, or a combination thereof.

This allows cloud computing environment 810 to offer infrastructure, platforms, and/or software as services for which a cloud consumer does not need to maintain resources on a local computing device. It is understood that the types of computing devices 800A-N shown in FIG. 8 are intended to be illustrative only and that computing nodes 800 and cloud computing environment 810 can communicate with any type of computerized device over any type of network and/or network addressable connection (e.g., using a web browser).

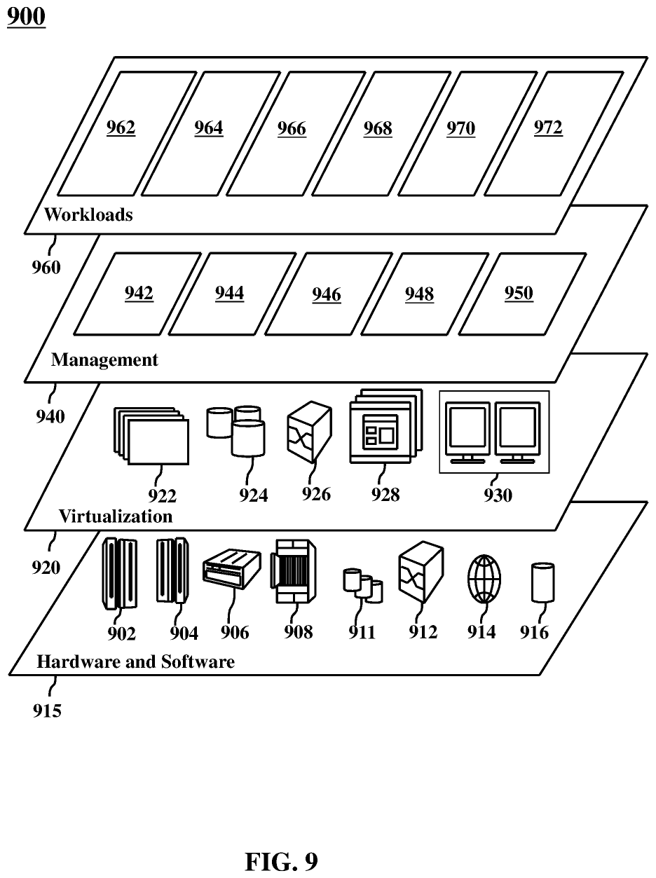

FIG. 9 illustrates abstraction model layers 900 provided by cloud computing environment 810 (FIG. 8) in accordance with embodiments of the present disclosure. It should be understood in advance that the components, layers, and functions shown in FIG. 9 are intended to be illustrative only and embodiments of the disclosure are not limited thereto. As depicted below, the following layers and corresponding functions are provided.

Hardware and software layer 915 includes hardware and software components. Examples of hardware components include: mainframes 902; RISC (Reduced Instruction Set Computer) architecture-based servers 904; servers 906; blade servers 908; storage devices 911; and networks and networking components 912. In some embodiments, software components include network application server software 914 and database software 916.

Virtualization layer 920 provides an abstraction layer from which the following examples of virtual entities may be provided: virtual servers 922; virtual storage 924; virtual networks 926, including virtual private networks; virtual applications and operating systems 928; and virtual clients 930.

In one example, management layer 940 may provide the functions described below. Resource provisioning 942 provides dynamic procurement of computing resources and other resources that are utilized to perform tasks within the cloud computing environment. Metering and pricing 944 provide cost tracking as resources and are utilized within the cloud computing environment as well as billing or invoicing for consumption of these resources. In one example, these resources may include application software licenses. Security provides identity verification for cloud consumers and tasks as well as protection for data and other resources. User portal 946 provides access to the cloud computing environment for consumers and system administrators. Service level management 948 provides cloud computing resource allocation and management such that required service levels are met. Service level agreement (SLA) planning and fulfillment 950 provide pre-arrangement for, and procurement of, cloud computing resources for which a future requirement is anticipated in accordance with an SLA.

Workloads layer 960 provides examples of functionality for which the cloud computing environment may be utilized. Examples of workloads and functions which may be provided from this layer include: mapping and navigation 962; software development and lifecycle management 964; virtual classroom education delivery 966; data analytics processing 968; transaction processing 970; and workload scheduler for high availability 972.

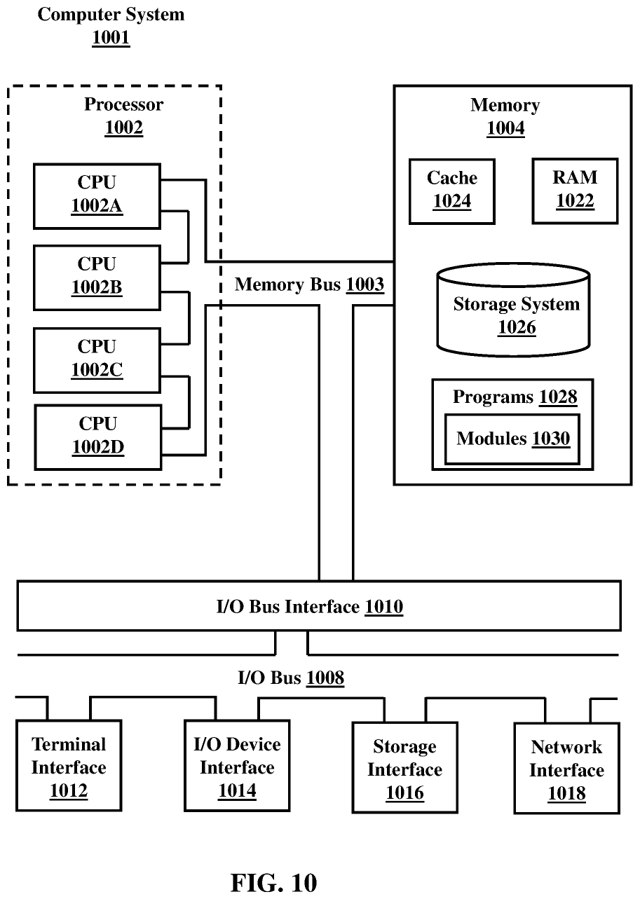

FIG. 10 illustrates a high-level block diagram of an example computer system 1001 that may be used in implementing one or more of the methods, tools, and modules, and any related functions, described herein (e.g., using one or more processor circuits or computer processors of the computer) in accordance with embodiments of the present disclosure. In some embodiments, the major components of the computer system 1001 may comprise a processor 1002 with one or more central processing units (CPUs) 1002A, 1002B, 1002C, and 1002D, a memory subsystem 1004, a terminal interface 1012, a storage interface 1016, an I/O (Input/Output) device interface 1014, and a network interface 1018, all of which may be communicatively coupled, directly or indirectly, for inter-component communication via a memory bus 1003, an I/O bus 1008, and an I/O bus interface unit 1010.

The computer system 1001 may contain one or more general-purpose programmable CPUs 1002A, 1002B, 1002C, and 1002D, herein generically referred to as the CPU 1002. In some embodiments, the computer system 1001 may contain multiple processors typical of a relatively large system; however, in other embodiments, the computer system 1001 may alternatively be a single CPU system. Each CPU 1002 may execute instructions stored in the memory subsystem 1004 and may include one or more levels of on-board cache.

System memory 1004 may include computer system readable media in the form of volatile memory, such as random access memory (RAM) 1022 or cache memory 1024. Computer system 1001 may further include other removable/non-removable, volatile/non-volatile computer system storage media. By way of example only, storage system 1026 can be provided for reading from and writing to a non-removable, non-volatile magnetic media, such as a “hard drive.” Although not shown, a magnetic disk drive for reading from and writing to a removable, non-volatile magnetic disk (e.g., a “floppy disk”), or an optical disk drive for reading from or writing to a removable, non-volatile optical disc such as a CD-ROM, DVD-ROM, or other optical media can be provided. In addition, memory 1004 can include flash memory, e.g., a flash memory stick drive or a flash drive. Memory devices can be connected to memory bus 1003 by one or more data media interfaces. The memory 1004 may include at least one program product having a set (e.g., at least one) of program modules that are configured to carry out the functions of various embodiments.

One or more programs/utilities 1028, each having at least one set of program modules 1030, may be stored in memory 1004. The programs/utilities 1028 may include a hypervisor (also referred to as a virtual machine monitor), one or more operating systems, one or more application programs, other program modules, and program data. Each of the operating systems, one or more application programs, other program modules, and program data, or some combination thereof, may include an implementation of a networking environment. Programs 1028 and/or program modules 1030 generally perform the functions or methodologies of various embodiments.

Although the memory bus 1003 is shown in FIG. 10 as a single bus structure providing a direct communication path among the CPUs 1002, the memory subsystem 1004, and the I/O bus interface 1010, the memory bus 1003 may, in some embodiments, include multiple different buses or communication paths, which may be arranged in any of various forms, such as point-to-point links in hierarchical, star, or web configurations, multiple hierarchical buses, parallel and redundant paths, or any other appropriate type of configuration. Furthermore, while the I/O bus interface 1010 and the I/O bus 1008 are shown as single respective units, the computer system 1001 may, in some embodiments, contain multiple I/O bus interface units 1010, multiple I/O buses 1008, or both. Further, while multiple I/O interface units 1010 are shown, which separate the I/O bus 1008 from various communications paths running to the various I/O devices, in other embodiments some or all of the I/O devices may be connected directly to one or more system I/O buses 1008.

In some embodiments, the computer system 1001 may be a multi-user mainframe computer system, a single-user system, a server computer, or similar device that has little or no direct user interface but receives requests from other computer systems (clients). Further, in some embodiments, the computer system 1001 may be implemented as a desktop computer, portable computer, laptop or notebook computer, tablet computer, pocket computer, telephone, smartphone, network switches or routers, or any other appropriate type of electronic device.

It is noted that FIG. 10 is intended to depict the representative major components of an exemplary computer system 1001. In some embodiments, however, individual components may have greater or lesser complexity than as represented in FIG. 10, components other than or in addition to those shown in FIG. 10 may be present, and the number, type, and configuration of such components may vary.

The present disclosure may be a system, a method, and/or a computer program product at any possible technical detail level of integration. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide, or other transmission media (e.g., light pulses passing through a fiber-optic cable) or electrical signals transmitted through a wire.

Computer readable program instructions described herein can be downloaded to respective computing/processing devices from a computer readable storage medium or to an external computer or external storage device via a network, for example, the Internet, a local area network, a wide area network, and/or a wireless network. The network may comprise copper transmission cables, optical transmission fibers, wireless transmission, routers, firewalls, switches, gateway computers, and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, configuration data for integrated circuitry, or source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer, or entirely on a remote computer or server. In the latter scenario, the remote computer may be connected to the user's computer through any type of network, including a local area network (LAN) or a wide area network (WAN) or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus, or other device to produce a computer implemented process such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments of the present disclosure. In this regard, each block in the flowchart or block diagrams may represent a module, segment, or portion of instructions which comprises one or more executable instructions for implementing the specified logical function(s). In some alternative implementations, the functions noted in the blocks may occur out of the order noted in the figures. For example, two blocks shown in succession may, in fact, be accomplished as one step, executed concurrently, substantially concurrently, in a partially or wholly temporally overlapping manner, or the blocks may sometimes be executed in the reverse order depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Although the present disclosure has been described in terms of specific embodiments, it is anticipated that alterations and modifications thereof will become apparent to the skilled in the art. The descriptions of the various embodiments of the present disclosure have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application, or the technical improvement over technologies found in the marketplace or to enable others of ordinary skill in the art to understand the embodiments disclosed herein. Therefore, it is intended that the following claims be interpreted as covering all such alterations and modifications as fall within the true spirit and scope of the disclosure.

What is claimed is:

1. A system, said system comprising:
a memory; and
a processor in communication with said memory, said processor being configured to perform operations, said operations comprising:
synchronizing a policy between a primary node and a compute node;
maintaining a resource registry on a client of said primary node;
communicating a direct communication between said client and said compute node, wherein said direct communication includes a first task; and
returning a first result for said first task directly from said compute node to said client.

2. The system of claim 1, said operations further comprising:
storing a task list on a local memory of said client.

3. The system of claim 1, said operations further comprising:
triggering said direct communication by a failure of said primary node.

4. The system of claim 1, said operations further comprising:
compiling a task history of said first task and said first result; and
reporting said task history to said primary node.

5. The system of claim 1, said operations further comprising:
scheduling said first task from said client to said compute node via said direct communication.

6. The system of claim 1, said operations further comprising:
searching said resource registry for resource availability.

7. The system of claim 1, said operations further comprising:
identifying said first task is within said policy.

8. A computer-implemented method, said method comprising:
synchronizing a policy between a primary node and a compute node;
maintaining a resource registry on a client of said primary node;
communicating a direct communication between said client and said compute node, wherein said direct communication includes a first task; and
returning a first result for said first task directly from said compute node to said client.

9. The computer-implemented method of claim 8, further comprising:
identifying a failure of said primary node.

10. The computer-implemented method of claim 8, further comprising:
storing a task list on a local memory of said client.

11. The computer-implemented method of claim 8, further comprising:
triggering said direct communication by a failure of said primary node.

12. The computer-implemented method of claim 8, further comprising:
compiling a task history of said first task and said first result; and
reporting said task history to said primary node.

13. The computer-implemented method of claim 8, further comprising:
scheduling said first task from said client to said compute node via said direct communication.

14. The computer-implemented method of claim 8, further comprising:
searching said resource registry for resource availability.

15. The computer-implemented method of claim 8, further comprising:
identifying said first task is within said policy.

16. A computer program product, said computer program product comprising a computer readable storage medium having program instructions embodied therewith, said program instructions executable by a processor to cause said processor to perform a function, said function comprising:
synchronizing a policy between a primary node and a compute node;
maintaining a resource registry on a client of said primary node;
communicating a direct communication between said client and said compute node, wherein said direct communication includes a first task; and
returning a first result for said first task directly from said compute node to said client.

17. The computer program product of claim 16, said function further comprising:
storing a task list on a local memory of said client.

18. The computer program product of claim 16, said function further comprising:
triggering said direct communication by a failure of said primary node.

19. The computer program product of claim 16, said function further comprising:
compiling a task history of said first task and said first result; and
reporting said task history to said primary node.

20. The computer program product of claim 16, said function further comprising:
scheduling said first task from said client to said compute node via said direct communication.
